(19) United States
(12) Patent Application Publication
(10) Pub. No.: US 2009/0099279 A1
(43) Pub. Date: Apr. 16, 2009

(54) Acrylated Polyaminoamide (III)

(75) Inventors: Antoine Carroy, Marlioz (FR); Jean-Marc Ballin, Noisy le Grand (FR); Laurence Druene, Perthes en Gatinais (FR); Morgan Garinet, Vaux le Peril (FR); Douglas Rhubright, Harleysville, PA (US)

Correspondence Address: FOX ROTHSCHILD LLP, 2000 MARKET STREET, PHILADELPHIA, PA, 19103, US

(73) Assignee: Cognis IP Management GmbH, Duesseldorf (DE)

(21) Appl. No.: 12/252,127

(22) Filed: Oct. 15, 2008

Related U.S. Application Data
(60) Provisional application No. 60/979,886, filed on Oct. 15, 2007.

(51) Int. Cl. C08F 2/46; C08G 63/91; C08G 73/06

(52) U.S. Cl. 522/173; 525/451; 525/421; 525/417

(57) ABSTRACT

Radiation-curable acrylated polyaminoamides obtainable by Michael addition of polyaminoamides containing terminal amine groups (A) and polyolester acrylates (B), the molar ratio of the acrylate groups in the polyolester acrylates (B) to the aminohydrogen groups in the polyaminoamides (A) being at least 1:1, characterized in that polyolester acrylates (B) are acrylated addition products of propylene oxide onto trimethylol propane, are suitable as radiation-curable compounds for the production of coatings.

### RELATED APPLICATIONS

The present application is related to and claims the priority benefit of provisional application 60/979,886, filed Oct. 15, 2007 which is incorporated herein in its entirety by reference as if fully set forth.

### FIELD OF THE INVENTION

This invention relates to special acrylated polyaminoamides and to their use for radiation-curable coatings.

### BACKGROUND AND RELATED ART

Acrylated amines were proposed some time ago as radiation-curable compounds for coating purposes. U.S. Pat. No. 3,963,771 (Union Carbide, 1976) discloses reaction products of acrylate esters with primary or secondary organic amines.

Coating compositions based on polyester (meth)acrylates and polyamines containing primary or secondary amino groups, the two compounds being reacted substantially stoichiometrically with one another, were also proposed more than 20 years ago in EP 231 442 A2 (PCI Polymerchemie, 1986).

EP 0 002 801 B1 discloses binders consisting of at least two compulsory components, namely (1) a vinyl addition polymer containing several primary or secondary amine groups which are attached to units in the polymer chain and (2) a material containing at least two acryloxy groups (Rohm & Haas, 1978).

U.S. Pat. No. 6,706,821 describes Michael addition products of amine-terminated polyolefins and polyfunctional acrylates.

DE 103 04 631 A1 describes light-sensitive resin compositions of the negative type. These compositions are Michael addition products of special polyamines with (bifunctional) polyethylene glycol di(meth)acrylates.

EP 0 002 457 B1 (Rohm & Haas, 1978) describes solid polyaminoester polymers comprising two units, namely (1) acrylate ester monomers with a functionality of at least 2.5 and (2) aliphatic amine monomers with a molecular weight of ≦1,000 and an NH equivalent weight of <100, the acrylate:NH equivalent ratio having to be in the range from 0.5 to 2.

U.S. Pat. No. 4,975,498 (Union Camp) describes heat-curable aminoamide acrylate polymers.

EP 381 354 B1 (Union Camp) describes a bonding process using a radiation-curable acrylate-modified aminoamide resin which is the Michael addition product of a thermoplastic aminoamide polymer having an amine value of more than 1 and less than 100 with a polyolester containing a number of acrylate ester groups (polyolester acrylate). The ratio of the original acrylate groups of the polyol ester to the original aminohydrogen groups of the aminoamide polymer is greater than 0.5 and less than 8. Michael addition is understood here to be the addition of an NH group onto a C═C group. It is clear from the specification of EP 381 354 B1 that the acrylate:NH ratio mentioned is meant to be understood as a product-by-process definition (cf. in particular page 3, lines 2-8; page 3, lines 53-56 and page 4, lines 15-31).

According to the later EP 505 031 A2 in the name of the same applicant, the Michael addition is carried out by reacting a mixture of aminoamide polymer and an NH-containing reactive diluent with the polyolester acrylate. According to WO 93/15151 (Union Camp), the Michael addition is carried out in aqueous dispersion.

A later application, WO 01/53376 A1 (Arizona Chemical Comp.), describes aminoamide acrylate polymers with a very special structure which can be obtained by Michael addition of special resin mixtures with multifunctional acrylate esters (for example TMP triacrylate).

U.S. Pat. No. 6,809,127 B2 (Cognis Corp.) describes liquid-radiation curable compositions containing the reaction product of an amine-terminated polyaminoamide and a mono- or polyacrylate.

WO 06/067639 A2 (Sun Chemical) describes radiation-curable acrylate-modified aminoamide resins. These resins are Michael adducts of thermoplastic aminoamide polymers—derived from polymerized unsaturated fatty acids (for example dimer fatty acids)- and polyolesters containing at least three acrylate groups per molecule. According to the document in question, the aminoamide polymer must have an amine value of 40 to 60 and the ratio of the original acrylate groups in the polyolester to the original amino groups of the aminoamide polymer must be at least 4:1.

WO 07/030,643 A1 (Sun Chemical) uses Michael adducts of polyolester acrylates with polyaminoamides for printing inks, the polyaminoamide being the reaction product of a polyamine with an acid component, with the proviso that this acid component contains two compulsory constituents, namely (a) a polymerized unsaturated fatty acid (for example dimer fatty acid) and (b) a fatty acid containing 2 to 22 carbon atoms.

### DETAILED DESCRIPTION OF PREFERRED EMBODIMENTS

As the documents discussed in the foregoing show, radiation-curable acrylated polyaminoamides on the one hand have a certain tradition, on the other hand there is a constant demand for improvements. In this context, the problem addressed by the present invention was to provide new radiation-curable acrylated polyaminoamides. These polyaminoamides would be suitable for coating purposes in general and for printing inks, preferably offset printing inks, in particular.

The present invention relates to radiation-curable acrylated polyaminoamides obtainable by Michael addition of polyaminoamides containing terminal amine groups (A) and polyolester acrylates (B), the molar ratio of the acrylate groups in the polyolester acrylates (B) to the aminohydrogen groups in the polyaminoamides (A) being at least 1:1, characterized in that the polyolester acrylates (B) are acrylated addition products of propylene oxide onto trimethylol propane. The expression “acrylate groups” in the context of the present invention is meant to encompass both acrylate groups and methacrylate groups and is used in the interests of terminological simplification.

In consistency with the prior art cited above, Michael addition is understood to be the addition reaction of an amino group onto an activated C═C double bond (typically of an ester). Formally, this may be expressed by the following reaction equation:

NH+C═CC(O)-->NC—CHC(O)

Such reactions generally take place spontaneously in the event of moderate heating. However, catalysts may also be used to accelerate the Michael addition.

Although, strictly speaking, this type of reaction would be better described as a “Michael-analogous” reaction, the handier term “Michael addition” used in the patent literature cited above is retained in the present specification. This is because it is clear to the expert what is meant by the term which, in any case, is defined in the foregoing.

As mentioned above, the compounds (A) and (B) are used for the production of the radiation-curable acrylated polyaminoamides according to the invention by Michael addition. These compounds are described in more detail in the following:

### Compounds (A)

The compounds (A) are polyaminoamides with terminal amine groups. These terminal amine groups may be primary or secondary, i.e. NH₂ or NH groups. Otherwise there are basically no other limitations as to the nature of the polyaminoamides.

The amine value of the polyaminoamides (A) is determined by HCl titration. In a preferred embodiment, it is above 40 and, more particularly, in the range from 45 to 70. In a preferred embodiment, the amine value of the polyaminoamides (A) is above 40 and, more particularly, in the range from 45 to 70.

The polyaminoamides (A) used are preferably compounds which can be obtained by reacting
carboxylic acids containing 2 to 54 carbon atoms per molecule and two COOH groups per molecule (i.e. dicarboxylic acids) and
diamines containing 2 to 36 carbon atoms.

In one embodiment, the dicarboxylic acids are selected from the group of dimer fatty acids, aliphatic α,ω-dicarboxylic acids containing 2 to 22 carbon atoms and dibasic aromatic carboxylic acids containing 8 to 22 carbon atoms.

Dimer fatty acids are preferably used as the dicarboxylic acids. As the expert is aware, dimer fatty acids are carboxylic acids obtainable by oligomerization of unsaturated carboxylic acids, generally fatty acids, such as oleic acid, linoleic acid, erucic acid and the like. The oligomerization is normally carried out at elevated temperature in the presence of a catalyst, for example of clay. The substances obtained—technical-quality dimer fatty acids—are mixtures in which the dimerization products predominate. However, the product mixture also contains small amounts of monomers (the sum total of monomers in the crude mixture of the dimer fatty acids is referred to by the expert as monomer fatty acids) and higher oligomers, more especially the so-called trimer fatty acids. Dimer fatty acids are commercially available products and are available in various compositions and qualities (for example under the name of Empol®, a product of the applicant).

In one embodiment, the dicarboxylic acids used are α,ω-dicarboxylic acids containing 2 to 22 carbon atoms, more particularly saturated dicarboxylic acids of this type. Examples include ethane dicarboxylic acid (oxalic acid), propane dicarboxylic acid (malonic acid), butane dicarboxylic acid (succinic acid), pentane dicarboxylic acid (glutaric acid), hexane dicarboxylic acid (adipic acid), heptane dicarboxylic acid (pimelic acid), octane dicarboxylic acid (suberic acid), nonane dicarboxylic acid (azelaic acid), decane dicarboxylic acid (sebacic acid), undecane dicarboxylic acid, dodecane dicarboxylic acid, tridecane dicarboxylic acid (brassylic acid), tetradecane dicarboxylic acid, pentadecane dicarboxylic acid, hexadecane dicarboxylic acid (thapsic acid), heptadecane dicarboxylic acid, octadecane dicarboxylic acid, nonadecane dicarboxylic acid, eicosane dicarboxylic acid.

In another embodiment, the dicarboxylic acids used are dibasic aromatic carboxylic acids containing 8 to 22 carbon atoms, for example isopthalic acid.

Another embodiment is characterized by the use of mixtures of various dicarboxylic acids, for example dimer fatty acid in admixture with at least one acid from the group of α,ω-dicarboxylic acids containing 2 to 22 carbon atoms.

As already mentioned, the diamines on which the polyaminoamides (A) are based are selected in particular from the group of diamines containing 2 to 36 carbon atoms. Examples of suitable diamines are ethylene diamine, hexamethylene diamine, diaminopropane, piperazine, aminoethyl piperazine, 4,4′-dipiperidine, toluene diamine, methylene dianiline, xylene diamine, methyl pentamethylene diamine, diaminocyclohexane, polyether diamine and diamines produced from dimer acid. The diamines are selected in particular from the group consisting of ethylene diamine, hexamethylene diamine, diaminopropane, piperazine and aminoethyl piperazine. Piperazine and aminoethyl piperazine are most particularly preferred.

In the production of the compounds (A) from dicarboxylic acids and diamines, it may desirable to carry out the reaction of dicarboxylic acids and diamines in the presence of small quantities of monocarboxylic acids containing 2 to 22 carbon atoms. In this case, the monocarboxylic acids are used in a quantity of 1 to 25% of the acid groups, based on the total number of acid groups ex dicarboxylic acids and monocarboxylic acids.

### Compounds (B)

The compounds (B) are acrylated addition products of propylene oxide onto trimethylol propane. These compounds can be obtained by esterification of addition products of propylene oxide onto trimethylol propane with acrylic acid and/or methacrylic acid, the full esters being preferred.

In the case of the full esters, the acrylate functionality of the compounds (B) is 3 and is therefore high enough to ensure that the compounds formed in the Michael addition of (A) and (B) still contain free C═C double bonds which are accessible to radiation curing. This is expressed by the wording “radiation-curable acrylated polyaminoamides” because the word “radiation-curable” implies that such C═C double bonds must be present.

It is expressly pointed out here that, in the context of the present specification, the expression “acrylate groups” encompasses both acrylate groups and methacrylate groups. In addition, the expression “acrylic acid” also encompasses the expression “methacrylic acid”.

Addition products of 1 to 30 mol propylene oxide per mol trimethylol propane and, more particularly, 2 to 10 mol propylene oxide per mol trimethylol propane are preferably used for the production of the compounds (B). The range from 3 to 6 mol propylene oxide per mol trimethylol propane is particularly preferred,

All these propoxylates are preferably fully esterified to the corresponding compounds (B), the acrylic acid esters being preferred.

### Michael Addition

As already mentioned, the radiation-curable acrylated polyaminoamides according to the invention are obtainable by Michael addition of the above-mentioned polyaminoamides (A) and the polyol ester acrylates (B). It was also mentioned that the molar ratio of acrylate groups in the polyol ester acrylates (B) to the aminohydrogen groups in the polyaminoamides (A) is at least 1:1.

Basically, the Michael addition may be carried out by any of the methods known to the expert.

In one embodiment, a solvent is used. In another embodiment, no solvent is used.

In another embodiment, a catalyst is used to accelerate the Michael addition. However, there is no need to use catalysts.

The Michael addition may be carried out in batches or continuously, batch processes being preferred.

In a preferred embodiment, the Michael addition is carried out by reacting the compounds (A) and (B) together for a few hours, generally for 1 to 5 hours, at temperatures in the range from 60 to 90° C. in the absence of solvents and catalysts. The compounds (B) and (A) are preferably used in a molar ratio of 1:1 to 3:1. A molar ratio of (B) to (A) of 3:1 is preferred. In this way, on a statistical average one NH function of the compounds (A) is attached to each acrylate function of the compounds (B) per Michael addition.

Nevertheless, it may be desirable to increase the molar ratio of (B) to (A) beyond the value of 3:1 theoretically sufficient for a quantitative reaction. On the one hand, it is possible in this way to modify the “fine structure” of the complex product mixture, on the other hand a mixture of Michael adduct and acrylate (B) is subsequently present (=after the Michael reaction) and may be used in this form as a radiation-curable composition. The “fine structure” of the product mixture is understood in particular to be the control of the molecular weight of the Michael adduct. It may be said in this regard that the larger the excess of polyol ester acrylate, i.e. the higher the molar ratio of (B) to (A) is above 3:1, the lower the molecular weight of the resulting Michael adduct tends to be.

Accordingly, in a preferred embodiment, the Michael reaction is carried out with a molar ratio of (B) to (A) of >3:1. A value of ca. 4:1 or higher is preferred.

### Coating Compositions

The present invention also relates to radiation-curable coating compositions containing a crosslinkable compound and a photoinitiator, the crosslinkable compound containing at least one acrylated polyaminoamide. All the foregoing observations apply in regard to the acrylated polyaminoamide. In a preferred embodiment, these compositions are compositions which additionally contain a pigment and which, hence, are printing inks. Corresponding compositions are preferably used for offset printing.

### EXAMPLES

### 1. Test Methods

Amine value: The amine values of polyaminoamide resins were determined by potentiometric titration with hydrochloric acid to DIN 53176. The results are expressed in “mg KOH/g test substance”.
Viscosity: The viscosities of UV offset inks were determined with a Bohlin C-VOR 120 rheometer (Malvern Instruments) at a shear rate of 100 sec⁻¹ and at a temperature of 25° C.
Yield point: The yield points of UV offset inks were determined using the rheology software of a Bohlin C-VOR 120 rheometer (Malvern Instruments).
Water absorption: The water absorption of UV offset inks was determined with a computer-controlled Lithotronic II tester (Novomatics GmbH) in conjunction with established measuring programs.
Solvent resistance: An acetone-soaked cottonwool pad was placed under a weight of 1000 g and moved in double strokes over the UV offset ink and UV overprint varnish surface. The solvent resistance is expressed as the number of double strokes completed before damage to the UV offset ink and UV overprint varnish surface is just visible.
Surface hardening: Surface hardening is expressed as the number of passes on a UV belt dryer of the M-40-2x1-R-TR-SLC-SO-INERT type (IST Metz) traveling at a constant speed which is required to obtain a scratch-resistant UV offset ink surface in the finger nail test.
Reactivity: The reactivity of UV overprint varnishes was determined by the maximum belt speed of a UV belt dryer of the M-40-2x1-R-TR-SLC-SO-INERT type (IST Metz) at which the cured UV overprint varnish film surface is still just scratch-resistant after the finger nail test.
Persoz pendulum hardness: The Persoz pendulum hardness of UV overprint varnish surfaces was determined to DIN 53157. The time in seconds required to reduce the amplitude of the pendulum from 12° to 4° was determined.
Pencil hardness: The pencil hardness of UV overprint varnish surfaces was determined to ISO 15184 on a hardness scale of 9B (soft) to 9H (very hard). The pencil hardness which produced a just visible scratch on the UV overprint varnish surface to be tested was determined.
Adhesion: Tesa No. 4104 adhesive tape was pressed onto the UV overprint varnish surface to be tested so firmly that no air bubbles could be trapped. The tape was then stripped off at a uniform rate and examined for the presence of any parts of the UV overprint varnish surface.

### 2. Production Examples

### Example 1

### Michael Adduct B1 According to the Invention

### a) Production of Amine-Terminated Polyaminoamide Resin

A resin reactor was charged with a mixture of 76.23 parts by weight Empol 1062 (hydrogenated dimer fatty acid; a Cognis product) and 23.77 parts by weight N-aminoethyl piperazine. This mixture was boiled under reflux for 1 hour, then heated to 210° C. and kept at that temperature until an amine value of 50 had been reached. The resin reactor was then cooled to 90° C.

### b) Production of Acrylated Resin (Michael Adduct B1)

63.38 parts by weight triacrylate of an addition product of 3 mol propylene oxide onto 1 mol trimethylol propane were introduced into a resin reactor and, after the addition of 0.1 part by weight of the inhibitor 2,6-di-tert.butyl-4-methylphenol, were heated to 60° C. 36.52 parts by weight of the amine-terminated polyaminoamide resin produced as described above in a) were added with stirring at a temperature of 90° C. The reaction mixture was kept at 70° C. for 2 hours, after which the Michael addition was terminated. The product obtained is called B1 in the following. B1 is an acrylated polyaminoamide. It may also be termed a polyamide acrylate.

### Example 2

### Comparison Michael Adduct C1

A Michael adduct was produced exactly in accordance with Example 1 of WO 2006/067639 A2 (cf. the paragraph spanning pages 8 and 9). As can be gathered from that Example, the polyaminoamide is based on dimer fatty acid and piperazine and has an amine number of 50; glycerol propoxylate triacrylate was used as the polyol ester acrylate. The Michael adduct obtained is referred to in the following as C1.

### Example 3

### Comparison Acrylate V2

A commercially available polyester acrylate, namely “Photomer 5432” (Cognis), was used. This polyester acrylate is referred to in the following as C2.

### 3. Application Examples

a) Production of UV Offset inks

UV offset inks were produced from the components listed in Table 1.

TABLE 1

| Component | Quantity (parts by weight) |
|---|---|
| Pigment | 18.0 |
| Oligomer acrylate | 22.8 |
| Epoxy acrylate | 21.0 |
| Monomer acrylate | 32.0 |
| UV stabilizer | 1.2 |
| Photoinitiator | 5.0 |

Pigments commercially available from Clariant and Ciba were used as pigments for the UV offset scale colors yellow, magenta, cyan and black. Compounds V1, C1 and C2 described above were used as the oligomer acrylate.
Photomer 3016 (Cognis) was used as the epoxyacrylate.
Photomer 4094 (propoxylated glycerol triacrylate, Cognis)) was used as the monomer acrylate
Florstab UV-1 (Kromachem) was used as the UV stabilizer
A mixture of Irgacure 369 and Irgacure 184 (both Ciba products) was used as the photoinitiator

### b) Production of UV Overprint Varnishes

UV overprint varnishes were produced from the components listed in Table 2.

TABLE 2

| Component | Quantity (parts by weight) |
|---|---|
| Oligomer acrylate | 60.0 |
| Monomer acrylate | 35.0 |
| Photoinitiator | 5.0 |

Compounds B1, C1 and C2 described above were used as the oligomer acrylate
Photomer 4017 F (hexane-1,6-diol diacrylate, Cognis) was used as the monomer acrylate
Darocur 1173 (Ciba) was used as the photoinitiator
   c) Property Profile of Polyamide Acrylate B1 in Comparison with Reference Compounds C1 and C2

### Print Testing of UV Offset Inks

All the UV offset inks were tested for their offset suitability using a Lithotronic II tester (Novomatics GmbH) and a Bohlin rheometer (Malvern Instruments).

To this end, all the UV offset inks were proofed on coated card of the Form 2A type (Leneta) using a Mikle Proofer (Labomat Essor) and a Little Joe Proofing Press (Little Joe Industries) and were then cured by exposure to a 180 W/cm mercury vapor lamp at a belt speed of 20 m/min. The ink films were each 6 μm thick.

The results of the tests are set out in Table 3.

TABLE 3

| | UV offset ink | UV offset ink | UV offset ink |
|---|---|---|---|
| | magenta with | magenta with | magenta with |
| | polyamide | reference | reference |
| Test | acrylate B1 | compound C2 | compound C1 |
| Viscosity in Pa · s | 22.1 | 25.7 | 31.1 |
| Yield point (Pa) | 31.7 | 45.0 | 41.8 |
| Water absorption (%) | 24.3 | 25.7 | 23.7 |
| Solvent resistance | 150 double | 170 double | 90 double |
| | strokes | strokes | strokes |
| Surface hardening | 1 Pass | 1 Pass | 1 Pass |

The UV offset ink magenta based on polyamide acrylate B1 according to the invention shows good offset properties and an ink rheology adapted to offset printing. With regard to solvent resistance, the UV offset ink magenta based on polyamide acrylate B1 according to the invention is superior to the UV offset ink magenta containing the reference compound C1.

### Performance Testing of UV Varnishes

All the UV overprint varnishes were applied to steel plates of the QD35 type (Q-Panel) and to corona-pretreated, PE-coated card of the Invercote G type (280 g/m² coated with 20 g/m² LDPE; Iggesund) using a No. 3 K coating bar from RK Print Coat Instruments Ltd. (wet film thickness: 24 μm) and were then cured by exposure to a 180 watt/cm mercury vapor lamp.

TABLE 4

| | UV overprint | | UV overprint | | UV overprint | |
|---|---|---|---|---|---|---|
| | varnish with | | varnish with | | varnish with | |
| | polyamide | | reference | | reference | |
| Test | acrylate B1 | | compound C2 | | compound C1 | |
| Reactivity | 10.6 | m/min | 9.8 | m/min | 8.6 | m/min |
| Persoz hardness | 161 | secs. | 222 | secs. | 136 | secs. |

| | | | |
|---|---|---|---|
| Pencil hardness | 4H | 6H | 4H |
| Adhesion to | OK | OK | Not OK |
| polyethylene- | | | |
| coated card | | | |
| Solvent resistance | >150 | >150 | >150 |

The results show that the UV overprint varnish based on polyamide acrylate B1 according to the invention has better adhesion to polyethylene film and higher reactivity than the UV overprint varnish containing reference compound C1 for comparable Persoz hardness.

On the basis of its property profile, the UV overprint varnish produced with polyamide acrylate B1 according to the invention is suitable for graphic applications and for industrial coatings on plastic, metal and wood surfaces.

What is claimed is:

1. A radiation-curable acrylated polyaminoamide obtainable by Michael addition of polyaminoamides containing terminal amine groups (A) and polyolester acrylates (B), the molar ratio of the acrylate groups in the polyolester acrylates (B) to the aminohydrogen groups in the polyaminoamides (A) being at least about 1:1, wherein the polyolester acrylates (B) are acrylated addition products of propylene oxide onto trimethylol propane.

2. The acrylated polyaminoamide of claim 1, wherein the polyaminoamides (A) are compounds obtainable by reaction of dicarboxylic acids and diamines, the dicarboxylic acids being selected from the group consisting of dimer fatty acids, α,ω-dicarboxylic acids containing 2 to 22 carbon atoms and aromatic dicarboxylic acids containing 8 to 22 carbon atoms, and the diamines being selected from the group of diamines containing 2 to 36 carbon atoms.

3. The acrylated polyaminoamide of claim 1, wherein the polyaminoamides (A) have an amine value above about 40.

4. The acrylated polyaminoamide of claim 1, wherein the diamines on which the polyaminoamides (A) are based are selected from the group consisting of ethylenediamine, hexamethylene diamine, diaminopropane, piperazine and aminoethyl piperazine.

5. The acrylated polyaminoamide of claim 4, wherein the diamine on which the polyaminoamides (A) are based is aminoethyl piperazine.

6. The acrylated polyaminoamide of claim 1, wherein the dicarboxylic acids on which the polyaminoamides (A) are based are selected from the group of dimer fatty acids.

7. The acrylated polyaminoamide of claim 1, wherein said compounds (B) are esters obtainable by reaction of acrylic and/or methacrylic acid with addition products of about 1 to about 30 mole of propylene oxide per mole of trimethylol propane.

8. The acrylated polyaminoamide of claim 1, wherein compounds (B) and (A) are used in a molar ratio of about 1:1 to about 3:1 in the Michael addition.

9. The acrylated polyaminoamide of claim 1, wherein compounds (B) and (A) are used in a molar ratio of at least about 3:1 in the Michael addition.

10. The acrylated polyaminoamide of claim 1, wherein compounds (B) and (A) are used in a molar ratio of at least about 4:1 in the Michael addition.

11. The acrylated polyaminoamide of claim 1, wherein, in the production of the compounds (A), the reaction of dicarboxylic acids and diamines is carried out in the presence of small quantities of monocarboxylic acids containing 2 to 22 carbon atoms.

12. The acrylated polyaminoamide of claim 11, wherein said monocarboxylic acids are used in a quantity of about 1 to about 25% of the acid groups, based on the total number of acid groups ex dicarboxylic acids and monocarboxylic acids.

13. A radiation-curable coating composition containing a crosslinkable compound and a photoinitiator, wherein the crosslinkable compound contains at least one acrylated polyaminoamide according to claim 1.

14. The composition of claim 13, further containing a pigment, wherein said composition is useful as a printing ink.

15. A method of offset printing comprising using the composition of claim 14 for offset printing.
